(19) United States
(12) Patent Application Publication
(10) Pub. No.: US 2026/0260928 A1
(43) Pub. Date: Sep. 3, 2026

(54) USE OF 1,1,1,3,5,5,5-HEPTAFLUORO-2-PENTENE IN NONAQUEOUS ELECTROLYTIC SOLUTION, NONAQUEOUS ELECTROLYTIC SOLUTION CONTAINING 1,1,1,3,5,5,5-HEPTAFLUORO-2-PENTENE, AND SECONDARY BATTERY INCLUDING SAID NONAQUEOUS ELECTROLYTIC SOLUTION

(71) Applicant: KANTO DENKA KOGYO CO., LTD., Tokyo (JP)

(72) Inventors: Tomohiro TANIGUCHI, Okayama (JP); Natsuho KAZAHAYA, Okayama (JP)

(21) Appl. No.: 18/859,906

(22) PCT Filed: Apr. 27, 2023
(86) PCT No.: PCT/JP2023/016586

§ 371 Date: Oct. 24, 2024

(30) Foreign Application Priority Data
Apr. 28, 2022 (JP) 2022-074900

(51) Int. Cl. H01M 10/056; H01M 10/0525

(52) U.S. Cl. CPC H01M 10/056; H01M 10/0525; H01M 2300/002; H01M 2300/0037

(57) ABSTRACT

Provided are: a novel use of 1,1,1,3,5,5,5-heptafluoro-2-pentene (HFO-1447), particularly a novel use of HFO-1447 in a nonaqueous electrolytic solution; a nonaqueous electrolytic solution containing HFO-1447; and a secondary battery including the nonaqueous electrolytic solution. Use of 1,1,1,3,5,5,5-heptafluoro-2-pentene in a nonaqueous electrolytic solution; and a nonaqueous electrolytic solution containing an electrolyte, 1,1,1,3,5,5,5-heptafluoro-2-pentene and a nonaqueous organic solvent; and a secondary battery including said nonaqueous electrolytic solution.

### TECHNICAL FIELD

The present invention relates to use of 1,1,1,3,5,5,5-heptafluoro-2-pentene in a nonaqueous electrolytic solution, anonaqueous electrolytic solution containing 1,1,1,3,5,5,5-heptafluoro-2-pentene in a nonaqueous electrolytic solution, and a secondary battery including said nonaqueous electrolytic solution.

### BACKGROUND ART

1,1,1,3,5,5,5-Heptafluoro-2-pentene (hereinafter sometimes referred to as “HFO-1447”) is a known compound of CAS No. (E)-HFO-1447: 1227064-59-6 and (Z)-HFO-1447: 1227064-60-9, but its uses are unknown.

### SUMMARY OF INVENTION

### Technical Problem

An object of the present invention is to provide a novel use of HFO-1447, particularly a novel use of HFO-1447 in a nonaqueous electrolytic solution, a nonaqueous electrolytic solution containing HFO-1447, and a secondary battery including the nonaqueous electrolytic solution.

### Solution to Problem

The present invention provides the following.
[1] Use of 1,1,1,3,5,5,5-heptafluoro-2-pentene in a nonaqueous electrolytic solution.
[2] The use according to [1], wherein the nonaqueous electrolytic solution is a nonaqueous electrolytic solution for a secondary battery.
[3] The use according to [2], wherein the secondary battery is a lithium ion secondary battery.
[4] The use according to [1], wherein the nonaqueous electrolytic solution contains: an electrolyte;
1,1,1,3,5,5,5-heptafluoro-2-pentene; and
a nonaqueous organic solvent.
[5] The use according to [4], wherein the electrolyte is lithium hexafluorophosphate, and the nonaqueous organic solvent is a carbonate solvent.
[6] The use according to any one of [1] to [5], wherein the 1,1,1,3,5,5,5-heptafluoro-2-pentene is (E)-1,1,1,3,5,5,5-heptafluoro-2-pentene, (Z)-1,1,1,3,5,5,5-heptafluoro-2-pentene, or a mixture of (E)-1,1,1,3,5,5,5-heptafluoro-2-pentene and (Z)-1,1,1,3,5,5,5-heptafluoro-2-pentene.
[7] A nonaqueous electrolytic solution containing:
an electrolyte;
1,1,1,3,5,5,5-heptafluoro-2-pentene; and
a nonaqueous organic solvent.
[8] The nonaqueous electrolytic solution according to [7], wherein the electrolyte is lithium hexafluorophosphate, and the nonaqueous organic solvent is a carbonate solvent.
[9] The nonaqueous electrolytic solution according to [7], wherein the 1,1,1,3,5,5,5-heptafluoro-2-pentene is (E)-1,1,1,3,5,5,5-heptafluoro-2-pentene, (Z)-1,1,1,3,5,5,5-heptafluoro-2-pentene, or a mixture of (E)-1,1,1,3,5,5,5-heptafluoro-2-pentene and (Z)-1,1,1,3,5,5,5-heptafluoro-2-pentene.
[10] A secondary battery including the nonaqueous electrolytic solution according to any one of [7] to [9].
[11] The secondary battery according to [10], wherein the secondary battery is a lithium ion secondary battery.

### Advantageous Effects of Invention

According to the present invention, a novel use of HFO-1447 in a nonaqueous electrolytic solution, a nonaqueous electrolytic solution containing HFO-1447, and a secondary battery including the nonaqueous electrolytic solution are provided. HFO-1447 can form a good film on the positive electrode and negative electrode interfaces, thereby providing excellent battery properties.

### BRIEF DESCRIPTION OF DRAWINGS

FIG. 1 is a schematic view of the laminate cell used for the battery evaluation in Examples.

FIG. 2 is a graph showing the progression of capacity retention rate in cycle tests carried out in the battery evaluation in Examples.

### DESCRIPTION OF EMBODIMENTS

### [Action]

The 1,1,1,3,5,5,5-heptafluoro-2-pentene (HFO-1447) to be used in the present invention can be represented by the following formula (1).

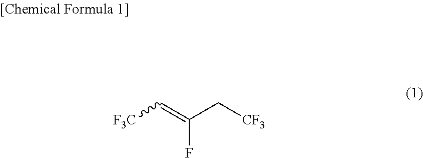 [SMILES: FC(=CC(F)(F)F)CC(F)(F)F]

As described herein later in Examples, the present inventors have newly found that HFO-1447 can form a good film on either one of the positive electrode or negative electrode interface or both of the positive electrode and negative electrode interfaces of a secondary battery, thereby providing excellent battery properties. This usefulness of HFO-1447 has been found experimentally, and it is believed to be due to the chemical structure of HFO-1447 as described below. A nonaqueous organic solvent is generally used for an electrolytic solution for a secondary battery, and a fluorine-based electrolyte such as hexafluorophosphate (LiPF₆) is added thereto as an electrolyte. HFO-1447 has high affinity with a fluorine compound due to its two trifluoromethyl groups and one fluoro group, whereas it also has a high affinity with a nonaqueous organic solvent and can be uniformly mixed in an electrolytic solution, due to its carbon chain as the basic skeleton. In addition, HFO-1447 can be stably present in an electrically polarized state due to the conjugation of between the C═C double bond and the electron pair of the fluoro group, each being located in the center of its molecule, so that it also has a high affinity with the positive electrode and negative electrode interfaces and can be stably present between the positive electrode and negative electrode. HFO-1447 is believed to be useful as an additive for an electrolytic solution for a secondary battery due to such characteristics of its chemical structure. Since HFO-1447 has a relatively high molecular weight of 196, the boiling point is 52° C. for (E)-HFO-1447 and 78° C. for (Z)-HFO-1447 and HFO-1447 is liquid at ordinary temperatures and pressures. HFO-1447 is self-extinguishing due to the presence of seven fluorine atoms in its molecule. One of the trifluoromethyl groups extending outward the molecule is linked to the C═C double bond, which is rigid, via a methylene group (—CH₂—), and accordingly, it has a relatively high degree of freedom so that the external attack of a reaction reagent to the C═C double bond is moderately limited. The 2,2,2-trifluoroethyl group attached to the C═C double bond is affected by the electron-withdrawing property of the terminal trifluoromethyl group, and it gives a moderate electron-withdrawing property to the C═C double bond due to the intervention of a methylene group, as compared to the trifluoromethyl group. Therefore, the reactivity of the C═C double bond is moderately limited. Due to such a chemical structure, the novel compound of the present invention is characterized in that it is liquid at ordinary temperatures and pressures, self-extinguishing and can be used in a chemically stable state, and also characterized in that after use, it can be recovered as low-molecular compounds as a result of cleavage of the C═C double bond. Due to such characteristics, HFO-1447 is believed to be useful as an additive for an electrolytic solution.

### [Use of HFO-1447 in Nonaqueous Electrolytic Solution]

As described above, the present inventors have newly found that HFO-1447 represented by formula (1) of the present invention can form a good film on the positive electrode and negative electrode interfaces of a secondary battery, thereby providing excellent battery properties. In addition, HFO-1447 is characterized due to its chemical structure in that it is liquid at ordinary temperatures and pressures, self-extinguishing and can be used in a chemically stable state, and also in that after use, it can be recovered as low-molecular compounds as a result of cleavage of the C═C double bond.

HFO-1447 has E- and Z-geometric isomer. Any of E-isomer, Z-isomer and a mixture of both can be used for the purpose of use of a novel electrolytic solution of the present invention.

When HFO-1447 is used as an additive for an electrolytic solution for a secondary battery, it is added to the electrolytic solution preferably in an amount of 0.005 to 10% by weight, more preferably 0.1 to 7.5% by weight, and most preferably 1 to 5% by weight, based on 100% by weight of the total amount of electrolytic solution.

Examples of the preferred composition of the electrolytic solution having HFO-1447 added thereto include the following composition.

### (Range of Composition of Electrolytic Solution)

### (1) Nonaqueous Organic Solvent: Balance

Examples of the nonaqueous organic solvent include, but not particularly limited to, a carbonate solvent such as ethylene carbonate or ethyl methyl carbonate, a chain carbonate ester, a phosphate ester, a cyclic ether, a chain ether, a lactone compound, a chain ester, a nitrile compound, an amide compound and a sulfone compound. Among these organic solvents, a carbonate solvent is preferred in view of common use as an organic solvent for a lithium secondary battery.

(2) Electrolyte: Preferably 0.1 to 2 Mol/L, More Preferably 0.15 to 1.8 Mol/L, and Most Preferably 0.3 to 1.2 Mol/L with Regard to the Volume of the Solvent

Examples of the electrolyte include, but not particularly limited to, fluorine-based electrolytes such as lithium hexafluorophosphate (LiPF₆), lithium borofluoride (LiBF₄), lithium trifluoromethanesulfonate (LiCF₃SO₃), LiBF₃CF₃, LiBF₃C₂F₅, LiC₂F₅SO₃, LiC₃F₇SO₃, LiC₄F₉SO₃, LiN(SO₂F)₂, LiN(CF₃SO₂)₂, LiN(C₂F₅SO₂)₂, LiN(C₂F₅SO₂)₂, LiN(CF₃SO₂)(CF₃CO), LiN(CF₃SO₂)(C₂F₅SO₂) and LiC(CF₃SO₂)₃. The electrolytes can be used singly or in combination of two or more thereof. Among these fluorine-based electrolyte, LiPF₆ is preferred in view of safety and stability of a nonaqueous electrolytic solution as well as improvement in electrical conductivity and cycle characteristics of a nonaqueous electrolytic solution.
(3) HFO-1447: it is added to the electrolytic solution, preferably in amount of 0.005 to 10% by weight, more preferably 0.1 to 7.5% by weight, and most preferably 1 to 5% by weight, based on 100% by weight of the total amount of electrolytic solution.
(4) Other optional additive components (such as fluoroethyl carbonate (FEC), vinylene carbonate (VC) and lithium difluorophosphate): they are added to the electrolytic solution in an amount of 0.005 to 10% by weight, more preferably 0.1 to 7.5% by weight, and most preferably 1 to 5% by weight, based on 100% by weight of the total amount of electrolytic solution.

### EXAMPLES

### Production Example 1

The HFO-1447 used in the evaluation of the battery properties was produced by the following method.

### (a) Synthesis of 3-Chloro-1,1,1,3,5,5,5-Heptafluoropentane (7F) at Low Temperature in the Presence of SbCl₅ Catalyst

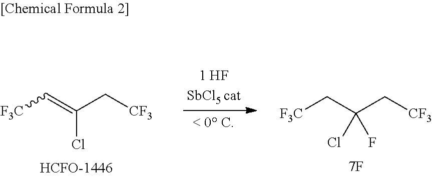 [SMILES: FC(F)(F)C=C(Cl)CC(F)(F)F ; FC(F)(F)CC(F)(Cl)CC(F)(F)F]

A 119.0 g portion (0.56 mol) of 3-chloro-1,1,1,5,5,5-hexafluoro-2-pentene (HCFO-1446) was added to a 100 ml PFA (perfluoroalkoxy alkane) reactor equipped with a thermometer, a condenser with chiller circulated at −20° C., and an inlet tube, and 12.3 g (0.61 mol, 1.1 eq.) of anhydrous HF (liquid) was introduced under cooling at −10° C. while stirring the reaction liquid. Then, 4.09 g (13.7 mmol, 2.5 mol %) of SbCl₅ was added, and the resultant was stirred at 0° C. for 48 hours. After stirring for 48 hours, 10 g of water was added under cooling at 0° C. to stop the reaction. The reaction liquid was transferred to a separatory funnel and subjected to liquid separation to quantitatively obtain 130.29 g of an organic layer containing 3-chloro-1,1,1,3,5,5,5-heptafluoropentene with a GC purity of 99%.

### (b) Synthesis of 1,1,1,3,5,5,5-Heptafluoro-2-Pentene by Dehydrochlorination of 3-Chloro-1,1,1,3,5,5,5-Heptafluoropentane with Activated Carbon Catalyst

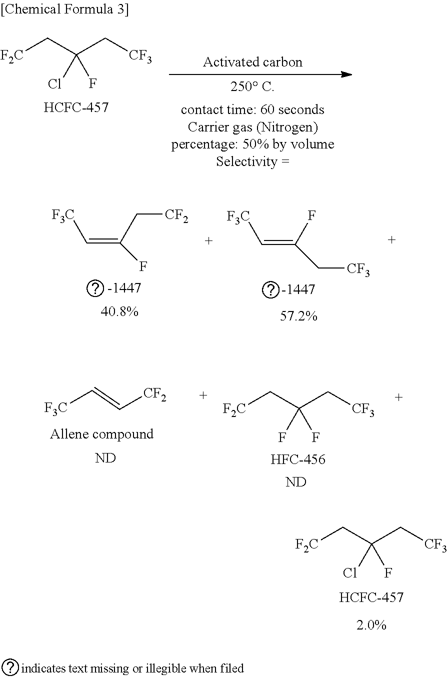

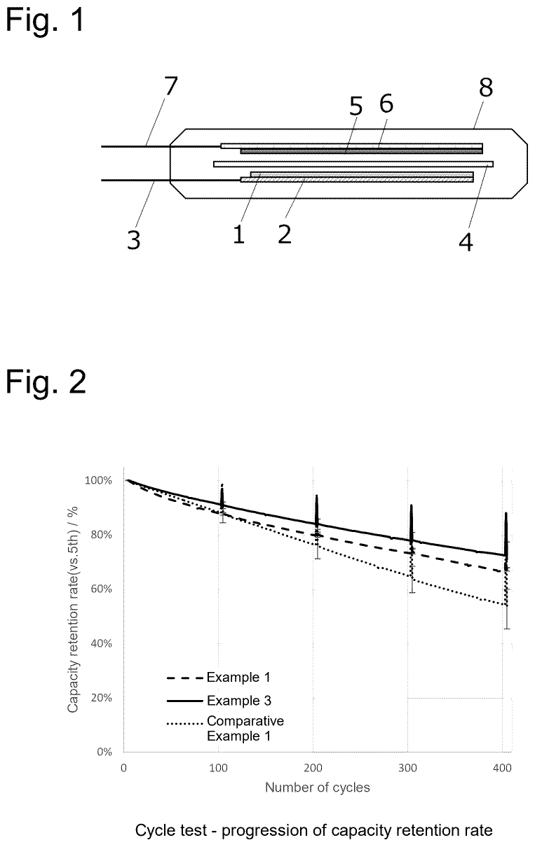

In the system shown in FIG. 1 including as a reactor a catalyst column (φ 20.0×400 mm) packed with activated carbon pellets (Shirasagi C2X4/6-2), the catalyst column was supplied with 3-chloro-1,1,1,3,5,5,5-heptafluoropentane (HCFC-457) at 25.7 ml/h (2.80 mmol/min, 63 SCCM) under the condition of heating the catalyst column at 250° C. and an evaporator at 150° C. while allowing nitrogen to flow at 63 SCCM. The mixed gas of HCFC-457 and N₂ was contacted with the activated carbon at a total flow rate of 125 SCCM for a contact time of 60 seconds, and the product was collected in a collection tank containing 300 g of ice water cooled to −2° C. After supplying HCFC-457 for 47 minutes, a pump was stopped. After white smoke was no longer seen in the collection tank, 23.22 g of an organic layer was recovered from the collection tank. Quantitative determination of the organic phase by NMR showed that: any allene compound was not detected (N.D.) and HFC-458 was not detected (N.D.); the composition of the organic phase was 40.8% of (E)-1,1,1,3,5,5,5-heptafluoro-2-pentene, 57.2% of (Z)-1,1,1,3,5,5,5-heptafluoro-2-pentene and 2.0% of HCFC-457; and 1,1,1,3,5,5,5-heptafluoro-2-pentene (a mixture of an (E)-isomer and a (Z)-isomer) was obtained with a conversion of 98% and a selectivity of >99%.

### (c) Distillation Purification of 1,1,1,3,5,5,5-Heptafluoro-2-Pentene Obtained in (b)

A 150.0 g portion of a crude liquid with a composition of (E)-HFO-1447/(Z)-HFO-1447/an allene compound/HFC-458/HCFC-457=40.8%/57.2%/N.D./N.D./2.0% was subjected to distillation purification in a distillation column equipped with a Kiriyama Pac (packing: SUS net) having a number of theoretical plates of 10 at a reflux ratio of 100/1. As a result, 55.0 g of (E)-HFO-1447 with a GC purity of >99% was obtained in a yield of 90% (the remaining 10% of the E isomer was obtained as a low purity fraction), and 80.7 g of (Z)-HFO-1447 with a GC purity of >99% was obtained in a yield of 94% (the remaining 6% of the Z isomer was obtained as a low purity fraction).

### [Evaluation of Battery]

In order to confirm that HFO-1447 has the effect of forming a good film in a nonaqueous electrolytic solution, a nonaqueous electrolytic solution secondary battery of a laminate cell shown in FIG. 1 was fabricated as a nonaqueous electrolytic solution secondary battery including the nonaqueous electrolytic solution containing HFO-1447, and subjected to an evaluation test.

### <Fabrication Procedure>

### [Structure of Battery Used]

The cross-section structure of the laminate cell used in the present evaluation test is shown in FIG. 1. In this laminate cell, positive electrode material 1 coats positive electrode current collector 2; positive electrode tab 3 extending from positive electrode current collector 2 can be electrically connected to a wiring from a measuring device with a clip; negative electrode material 5 coats negative electrode current collector 6; negative electrode tab 7 extending from negative electrode current collector 6 can be electrically connected to a wiring from the measuring device with a clip; and separator 4 is placed between positive electrode material 1 and negative electrode material 5. Each member has a flat rectangular shape. The members are arranged in layers in the following order: positive electrode current collector 2, positive electrode material 1, separator 4, negative electrode material 5 and negative electrode current collector 6, and are housed in laminate sheath 8.

### [Battery Members Used]

The positive electrode to be used was a lithium nickel cobalt manganese oxide (NCM111) electrode applied onto an aluminum current collector, and the negative electrode to be used was an artificial graphite electrode applied onto a nickel current collector. The thickness of the positive electrode material (coating area in the electrode) was 53 m, and the thickness of the negative electrode material was about 56 m. A polypropylene microporous membrane (manufactured by Celgard; the trade name “Celgard #2400”) was cut to 5 cm×6.5 cm and used as the separator. The laminate sheath to be used was obtained by folding a laminate with a size of 11 cm×20 cm in half, and a laminate cell with the configuration shown in FIG. 1 was fabricated.

### [Assembling Battery]

In the above laminate cell, NCM111 was used for the positive electrode and artificial graphite was used for the negative electrode, each of which was used after being cut to a specified size. A tab for clamping an alligator clip was welded to each electrode, and a separator was sandwiched between the positive electrode and the negative electrode, which was in turn placed in the laminate cell and dried for 1 hour at 100° C. Thereafter, 0.5 ml of the electrolytic solution containing the HFO-1447 synthesized in Production Example 1 was poured thereinto in an Ar glove box, and the laminate cell was sealed in a vacuum state using a laminator.

### Example 1

Ethylene carbonate (EC) and ethyl methyl carbonate (EMC) were mixed at a volume ratio of EC:EMC=3:7 to obtain a nonaqueous solvent, and in the nonaqueous solvent, lithium hexafluorophosphate LiPF₆ as an electrolyte was dissolved to a content of 1 mol/L to obtain a solution. To the solution, HFO-1447 (Z) obtained by the synthesis and purification in Production Example 1 was added in an amount of 1% by weight based on 100% by weight of the total amount of the resulting electrolytic solution, to prepare a nonaqueous electrolytic solution. Then, a nonaqueous electrolytic solution secondary battery of a laminate cell as shown in FIG. 1 was fabricated.

### Example 2

Ethylene carbonate (EC) and ethyl methyl carbonate (EMC) were mixed at a volume ratio of EC:EMC=3:7 to obtain a nonaqueous solvent, and in the nonaqueous solvent, lithium hexafluorophosphate LiPF₆ as an electrolyte was dissolved to a content of 1 mol/L to obtain a solution. To the solution, HFO-1447 (Z) obtained by the synthesis and purification in Production Example 1 was added in an amount of 2.5% by weight based on 100% by weight of the total amount of the resulting electrolytic solution, to prepare a nonaqueous electrolytic solution. Then, a nonaqueous electrolytic solution secondary battery of a laminate cell as shown in FIG. 1 was fabricated.

### Example 3

Ethylene carbonate (EC) and ethyl methyl carbonate (EMC) were mixed at a volume ratio of EC:EMC=3:7 to obtain a nonaqueous solvent, and in the nonaqueous solvent, lithium hexafluorophosphate LiPF₆ as an electrolyte was dissolved to a content of 1 mol/L to obtain a solution. To the solution, HFO-1447 (Z) obtained by the synthesis and purification in Production Example 1 was added in an amount of 5% by weight based on 100% by weight of the total amount of the resulting electrolytic solution, to prepare a nonaqueous electrolytic solution. Then, a nonaqueous electrolytic solution secondary battery of a laminate cell as shown in FIG. 1 was fabricated.

### Example 4

Ethylene carbonate (EC) and ethyl methyl carbonate (EMC) were mixed at a volume ratio of EC:EMC=3:7 to obtain a nonaqueous solvent, and in the nonaqueous solvent, lithium hexafluorophosphate LiPF₆ as an electrolyte was dissolved to a content of 1 mol/L to obtain a solution. To the solution, HFO-1447 (Z) obtained by the synthesis and purification in Production Example 1 was added in an amount of 10% by weight based on 100% by weight of the total amount of the resulting electrolytic solution, to prepare a nonaqueous electrolytic solution. Then, a nonaqueous electrolytic solution secondary battery of a laminate cell as shown in FIG. 1 was fabricated.

### Comparative Example 1

Ethylene carbonate (EC) and ethyl methyl carbonate (EMC) were mixed at a volume ratio of EC:EMC=3:7 to obtain a nonaqueous solvent, and in the nonaqueous solvent, lithium hexafluorophosphate LiPF₆ as an electrolyte was dissolved to a content of 1 mol/L to obtain a nonaqueous electrolytic solution. Then, a nonaqueous electrolytic solution secondary battery of a laminate cell as shown in FIG. 1 was fabricated. This is an example of the electrolytic solution to which the HFO-1447 synthesized in Production Example 1 was not added.

### [Measurement Method]

In order to vent the gas initially generated, each of the secondary batteries fabricated by using the nonaqueous electrolytic solutions of Examples 1 to 4 and Comparative Example 1, respectively, was subjected to constant-current charging at of 0.2 C at a temperature of 60° C. to reach 30% of the theoretical capacity, and then stored for 15 hours. (Aging, 1^{st} charging) Thereafter, each of the above-described aged secondary batteries fabricated by using the nonaqueous electrolytic solution of Examples 1 to 4 and Comparative Example 1, respectively, was placed in an Ar glove box. The edge of the laminate cell was cut, and gas was vented. The laminate cell was sealed again in a vacuum state with a laminator. (Gas venting)

Next, each of the secondary batteries fabricated by using the nonaqueous electrolytic solutions of Examples 1 to 4 and Comparative Example 1, respectively, was subjected to constant-current charging at 0.2 C at a temperature of 25° C. to reach 4.2 V, further subjected to constant-voltage charging at a charging termination C current of 0.02 C until the current value reached 1/50 of the theoretical capacity corresponding to the weight of the active material, and then subjected to discharging at a constant current of 0.2 C to reach 2.75 V. (2^{nd} and 3^{rd} charging/discharging)

Next, each of the secondary batteries fabricated by using the nonaqueous electrolytic solutions of Examples 1 to 4 and Comparative Example 1, respectively, was subjected to constant-current charging at 1 C at a temperature of 25° C. to reach 4.2 V, further subjected to constant-voltage charging at a charging termination C current of 0.1 C until the current value reached 1/10 of the theoretical capacity corresponding to the weight of the active material, and then subjected to discharging at a constant current of 1 C to reach 50% of the theoretical capacity. (4^{th} charging/discharging)

Thereafter, each of the secondary batteries fabricated by using the nonaqueous electrolytic solutions of Examples 1 to 4 and Comparative Example 1, respectively, was subjected to constant-current charging at 1 C at a temperature of 45° C. to 4.2 V, further subjected to constant-voltage charging at a charging termination C current of 0.1 C until the current value reached 1/10 of the theoretical capacity corresponding to the weight of the active material, and then subjected to discharging at a constant current of 1 C to reach 2.75 V. (5^{th}~charging/discharging)

Every 100 cycles, the second battery was subjected to constant-current charging at 0.2 C to reach 4.2V, further subjected to constant-voltage charging at a charging termination C current of 0.1 C until the current value reached 1/10 of the theoretical capacity corresponding to the weight of the active material, and then subjected to discharging at a constant current of 1 C to reach 2.75 V.

Based on the first (5^{th}) discharge capacity D₅ and the x^{th} discharge capacity Dx (x=105, 205, 305, 405) measured at a temperature of 45° C. and at 1 C as described above, the capacity retention rate (%) after the x^{th} cycle of each of the secondary batteries fabricated by using the nonaqueous electrolytic solution of Examples 1 to 4 and Comparative Example 1, respectively, was calculated using the following equation. The results are shown in Table 1.

$$Capacity retention rate ( \% ) = ( {D}_{x} / {D}_{5} ) \times 100$$

The sum of the discharge capacities of the cycles up to the 405^{th} cycle is also shown as the total discharge capacity in Table 2.

TABLE 1

| | | | Capacity retention rate (vs. 5^{th})(%) | | | |
|---|---|---|---|---|---|---|
| | | Amount | 105^{th} | 205^{th} | 305^{th} | 405^{th} |
| | Additive | added | Cycle | Cycle | Cycle | Cycle |
| Example 1 | HFO- | 1 wt % | 87.7% | 80.0% | 73.8% | 67.2% |
| | 1447(Z) | | | | | |
| Example 2 | HFO- | 2.5 wt % | 90.0% | 81.7% | 74.6% | 67.3% |
| | 1447(Z) | | | | | |
| Example 3 | HFO- | 5 wt % | 90.8% | 83.9% | 77.9% | 72.6% |
| | 1447(Z) | | | | | |
| Example 4 | HFO- | 10 wt % | 94.8% | 91.6% | 88.2% | 85.0% |
| | 1447(Z) | | | | | |
| Comparative | None | — | 87.6% | 75.8% | 63.5% | 52.6% |
| Example 1 | | | | | | |

TABLE 2

| | | | | | | | Total |
|---|---|---|---|---|---|---|---|
| | | | Discharge capacity (mAh) | | | | discharge |
| | | Amount | 105^{th} | 205^{th} | 305^{th} | 405^{th} | capacity |
| | Additive | added | Cycle | Cycle | Cycle | Cycle | (mAh) |
| Example 1 | HFO- | 1 wt % | 37.07 | 33.84 | 31.18 | 28.40 | 13877.53 |
| | 1447(Z) | | | | | | |
| Example 2 | HFO- | 2.5wt % | 38.15 | 34.61 | 31.60 | 28.50 | 14162.34 |
| | 1447(Z) | | | | | | |
| Example 3 | HFO- | 5 wt % | 36.96 | 34.16 | 31.72 | 29.56 | 14006.53 |
| | 1447(Z) | | | | | | |
| Example 4 | HFO- | 10 wt % | 34.60 | 33.44 | 32.19 | 31.01 | 13609.57 |
| | 1447(Z) | | | | | | |
| Compar- | None | — | 38.39 | 33.21 | 27.83 | 23.04 | 13601.42 |
| ative | | | | | | | |
| Example 1 | | | | | | | |

Table 1 shows that Examples 1 to 4 had a higher capacity retention rate at the 105^{th} cycle than Comparative Example 1 and were excellent in cycle characteristics. Table 1 also shows that from the 105^{th} cycle to the 405^{th} cycle, further differences in capacity retention rate occurred between each Example and Comparative Example, indicating that 1,1,1,3,5,5,5-heptafluoro-2-pentene (HFO-1447) represented by formula (1) contributed to maintaining the discharge capacity after long-term cycles. It was found that HFO-1447 formed a good film on the positive electrode and negative electrode interfaces to successfully provide excellent battery properties. It was also found that the capacity retention rate was improved as the amount of HFO-1447 to be added increased from 1% by weight to 10% by weight. Table 2 shows that the total discharge capacity was highest when the amount of HFO-1447 to be added was 2.5% by weight. From these findings, it was also found that the capacity retention rate and the total discharge capacity can be appropriately controlled by adjusting the amount of HFO-1447 to be added.

### Examples 5 and 6

HFO-1447 was subjected to an isomer evaluation at an amount added of 2.5% by weight, at which the total discharge capacity had been highest at the time of the 405^{th} cycle.

Ethylene carbonate (EC) and ethyl methyl carbonate (EMC) were mixed at a volume ratio of EC:EMC=3:7 to obtain a nonaqueous solvent, and in the nonaqueous solvent, lithium hexafluorophosphate LiPF₆ as an electrolyte was dissolved to a content of 1 mol/L to obtain a solution. To the solution, HFO-1447 (E) (Example 5) or HFO-1447 (E/Z) (Example 6; a mixture of E-isomer and Z-isomer, a molar ratio of E-isomer:Z-isomer=4:6) obtained by synthesis and purification in Production Example 1 was added in an amount of 2.5% by weight based on 100% by weight of the total amount of the resulting electrolytic solution, to prepare a nonaqueous electrolytic solution. Then, a nonaqueous electrolytic solution secondary battery of a laminate cell as shown in FIG. 1 was fabricated. The data for HFO-1447(Z) from Example 2 was used for comparison.

The capacity retention rate (%) after the x^{th} cycle of each of the secondary batteries fabricated by using the nonaqueous electrolytic solution of Example 5 and 6, respectively, was determined in the same manner as in Example 1. The results are shown in Table 3. In addition, the sum of the discharge capacities of the cycles up to the 405^{th} cycle is also shown as the total discharge capacity in Table 4.

TABLE 3

| | | | Capacity retention rate (vs. 5^{th})(%) | | | |
|---|---|---|---|---|---|---|
| | | Amount | 105^{th} | 205^{th} | | 405^{th} |
| | Additive | added | Cycle | Cycle | 305^{th} Cycle | Cycle |
| Example 5 | HFO-1447(E) | 2.5 wt % | 90.2% | 80.1% | 71.2% | 62.7% |
| Example 2 | HFO-1447(Z) | 2.5 wt % | 90.0% | 81.7% | 74.6% | 67.3% |
| Example 6 | HFO-1447(E/Z) | 2.5 wt % | 89.5% | 80.4% | 71.8% | 64.2% |

TABLE 4

| | | | | | | | Total |
|---|---|---|---|---|---|---|---|
| | | | Discharge capacity (mAh) | | | | discharge |
| | | Amount | 105^{th} | 205^{th} | 305^{th} | 405^{th} | capacity |
| | Additive | added | Cycle | Cycle | Cycle | Cycle | (mAh) |
| Example 5 | HFO-1447(E) | 2.5 wt % | 38.46 | 34.69 | 30.85 | 27.17 | 14092.31 |
| Example 2 | HFO-1447(Z) | 2.5 wt % | 38.15 | 34.61 | 31.6 | 28.50 | 14162.34 |
| Example 6 | HFO-1447(E/Z) | 2.5 wt % | 37.89 | 34.05 | 30.41 | 27.17 | 13868.14 |

Table 3 shows that no marked difference was found in capacity retention rate depending on the isomer ratio of E-isomer:Z-isomer of HFO-1447. In Table 4, little difference was found in capacity retention rate depending on the isomer ratio of E-isomer:Z-isomer of HFO-1447; however, Table 4 shows that reflecting the slightly higher capacity retention rate given by the Z-isomer, the total discharge capacity tended to be the highest for the Z-isomer among HFO-1447 as the number of cycles increased. In addition, it was found that since the boiling point of HFO-1447 is 52° C. for the E-isomer and 78° C. for the Z-isomer, the boiling point of the additive can be changed by as much as 26° C. even though the isomers given the same battery properties as each other.

1. Use of 1,1,1,3,5,5,5-heptafluoro-2-pentene in a nonaqueous electrolytic solution.

2. The use according to claim 1, wherein the nonaqueous electrolytic solution is a nonaqueous electrolytic solution for a secondary battery.

3. The use according to claim 2, wherein the secondary battery is a lithium ion secondary battery.

4. The use according to claim 1, wherein the nonaqueous electrolytic solution comprises:
an electrolyte;
1,1,1,3,5,5,5-heptafluoro-2-pentene; and
a nonaqueous organic solvent.

5. The use according to claim 4, wherein the electrolyte is lithium hexafluorophosphate, and the nonaqueous organic solvent is a carbonate solvent.

6. The use according to claim 1, wherein the 1,1,1,3,5,5,5-heptafluoro-2-pentene is (E)-1,1,1,3,5,5,5-heptafluoro-2-pentene, (Z)-1,1,1,3,5,5,5-heptafluoro-2-pentene, or a mixture of (E)-1,1,1,3,5,5,5-heptafluoro-2-pentene and (Z)-1,1,1,3,5,5,5-heptafluoro-2-pentene.

7. A nonaqueous electrolytic solution comprising:
an electrolyte;
1,1,1,3,5,5,5-heptafluoro-2-pentene; and
a nonaqueous organic solvent.

8. The nonaqueous electrolytic solution according to claim 7, wherein the electrolyte is lithium hexafluorophosphate, and the nonaqueous organic solvent is a carbonate solvent.

9. The nonaqueous electrolytic solution according to claim 7, wherein the 1,1,1,3,5,5,5-heptafluoro-2-pentene is (E)-1,1,1,3,5,5,5-heptafluoro-2-pentene, (Z)-1,1,1,3,5,5,5-heptafluoro-2-pentene, or a mixture of (E)-1,1,1,3,5,5,5-heptafluoro-2-pentene and (Z)-1,1,1,3,5,5,5-heptafluoro-2-pentene.

10. A secondary battery comprising the nonaqueous electrolytic solution according to claim 7.

11. The secondary battery according to claim 10, wherein the secondary battery is a lithium ion secondary battery.

12. The use according to claim 2, wherein the 1,1,1,3,5,5,5-heptafluoro-2-pentene is (E)-1,1,1,3,5,5,5-heptafluoro-2-pentene, (Z)-1,1,1,3,5,5,5-heptafluoro-2-pentene, or a mixture of (E)-1,1,1,3,5,5,5-heptafluoro-2-pentene and (Z)-1,1,1,3,5,5,5-heptafluoro-2-pentene.

13. The use according to claim 3, wherein the 1,1,1,3,5,5,5-heptafluoro-2-pentene is (E)-1,1,1,3,5,5,5-heptafluoro-2-pentene, (Z)-1,1,1,3,5,5,5-heptafluoro-2-pentene, or a mixture of (E)-1,1,1,3,5,5,5-heptafluoro-2-pentene and (Z)-1,1,1,3,5,5,5-heptafluoro-2-pentene.

14. The use according to claim 4, wherein the 1,1,1,3,5,5,5-heptafluoro-2-pentene is (E)-1,1,1,3,5,5,5-heptafluoro-2-pentene, (Z)-1,1,1,3,5,5,5-heptafluoro-2-pentene, or a mixture of (E)-1,1,1,3,5,5,5-heptafluoro-2-pentene and (Z)-1,1,1,3,5,5,5-heptafluoro-2-pentene.

15. The use according to claim 5, wherein the 1,1,1,3,5,5,5-heptafluoro-2-pentene is (E)-1,1,1,3,5,5,5-heptafluoro-2-pentene, (Z)-1,1,1,3,5,5,5-heptafluoro-2-pentene, or a mixture of (E)-1,1,1,3,5,5,5-heptafluoro-2-pentene and (Z)-1,1,1,3,5,5,5-heptafluoro-2-pentene.

16. A secondary battery comprising the nonaqueous electrolytic solution according to claim 8.

17. The secondary battery according to claim 16, wherein the secondary battery is a lithium ion secondary battery.

18. A secondary battery comprising the nonaqueous electrolytic solution according to claim 9.

19. The secondary battery according to claim 18, wherein the secondary battery is a lithium ion secondary battery.
